(19) United States
(12) Patent Application Publication
(10) Pub. No.: US 2007/0018442 A1
(43) Pub. Date: Jan. 25, 2007

(54) Vehicle driver and passenger restraining device

(76) Inventor: Ming Yat Kwok, Vancouver (CA)

Correspondence Address: Ming Yat Kwok, 1646 Frances St, Vancouver, V5L 1Z4, CA

(21) Appl. No.: 11/186,888

(22) Filed: Jul. 22, 2005

(51) Int. Cl. B60R 21/06

(52) U.S. Cl. 280/749

(57) ABSTRACT

A vehicle driver and passenger restraining device has a web (30) of which the bottom ends strap across the laps of the driver/passenger (11) and buckle up to the female receptacles (70) of which are adjustable. Of the two top ends one of which fixes to the solid fixture of the ceiling at one side of the chair slightly behind. When in ready position the other end feeds into the cable guide (20) which in turn hooks onto the carrying cam (80) and placed next to the fixed end. The web (30) is folded in pleats and slightly restrained. The propellant chamber (50) when received the signal of an imminent collision will propel the carrying cam (80) together with the cable guide (20) and the mobile end of the web (30) routes through the looped channel (40) thereby looped and restrained the person when the carrying cam entered the anchor-bracket (60).

### BACKGROUND—FIELD OF INVENTION

The present invention relates to driver and passenger safety restraining system during an accident.

### BACKGROUND—DESCRIPTION OF PRIOR ART (REFER TO Ser. No. 11/093,294)

Seatbelts and air bags are the protection devices for the present day vehicle occupants. Sadly, in America and all over the world thousands of fatalities still occur every day and many thousands more are seriously injured. While seatbelts do have some protection but are often ineffective at times either when occupants do not put them on for various reasons or they are worn incorrectly or yet the seatbelt system malfunction. The most common malfunction of the seatbelt system is the shoulder belt, it does not seem to be able to lock up when needed the most. Studies show that violent movement during an accident results in most injuries. Seatbelts are not the solution, then air bag was invented, one airbag first, then two and then four, there will be more airbags yet to come in the newer vehicles. Airbags help cushion the driver against the steering column during the initial crash and not much more, the human body still has to endure the violent thrust during the collision and that is the major cause of injuries and fatalities. Airbags help during the initial impact but offer no help at all if there is any subsequent collision following. The cost to replace a spent airbag and repair the damages caused by the discharge of the airbags is huge.

In U.S. Pat. No. 6,502,859 B1 (2003) issued to Robert W. Svetlik describe a back seat 3 net enclosure to protect the occupants of a vehicle during an accident, but nothing illustrated about restraining occupants from thrust against the ceiling and the rear window.

In U.S. Pat. No. 5,226,672 issued to Royce H Husted (1993) is disclosing a web restraining about ⅓ the body of a driver while holding the steering wheel near the bottom, chances are, during an accident, the lower part of the body will slip down and thrust forward and the web might not be able to stop that thrust. Some drivers prefer to put one or both their hands on top of the steering wheel while driving, then the web will only cover the head and neck of that person and that can be detrimental.

The present invention deploys a see-through web folded in pleats with reinforced portions and rims and the lower ends strapped across the laps of a person and buckled down and one of the two upper ends fixed at one side of the chair and the other end is mobile when in ready mode hangs loose next to the stationary end. Giving the signal of an imminent collision the propelling chamber will discharge a bouncing ball which will propel the carrying cam that has the cable guide and the web along a looped channel and stopped at the anchor bracket effectively looped and restrained a person from the impact.

### OBJECT OF THE INVENTION

A principle object of the invention is to provide a restraining safety web device for the driver and passenger of vehicle during an accident.

Another object of the invention is to provide a restraining device that will allow the person restrained arms free continue maneuvering.

Another object of the invention is to provide a device that after use can be reset again for use.

Another object of the invention is to provide a restraining device that after deployed can be unbuckled and the person restrained can walk away.

Another object of the invention is to provide a restraining device minimizing the movement of the body of a person during an accident which in turn protect the vital neck and spine of a retrained person.

Yet another objection of the invention is to provide an effective, simple, easy to make and low cost to build restraining device.

### BRIEF DESCRIPTION OF THE DRAWINGS

These and other objects and advantages of the invention will be apparent upon reading the following description in conjunction with the drawings, in which:

FIG. 1 is the frontal view of a person sitting in a seat of a vehicle with the restraining device deployed.

FIG. 2 is the side view of a driver of a vehicle sitting in a seat with a hand on the steering wheel and the restraining device deployed.

FIG. 3 is showing the restraining device in normal ready position.

FIG. 4 is the enlarged view of the driver and passenger restraining device lay out independently.

FIG. 5 is the propelling chamber connecting with the looped channel and their dismantled parts.

FIG. 6 is the carrying cam viewed from different positions. (refer to Ser. No. 11/100,236)

FIG. 7 is the carrying cam taken apart. (refer to Ser. No. 11/100,236)

FIG. 8 is the anchor bracket joining the looped channel and also viewing individual parts when taken apart.

FIG. 9 is the cable guide looking from the feeding front view and side way and with the flaps taken apart.

### DESCRIPTION OF THE PREFERRED EMBODIMENT

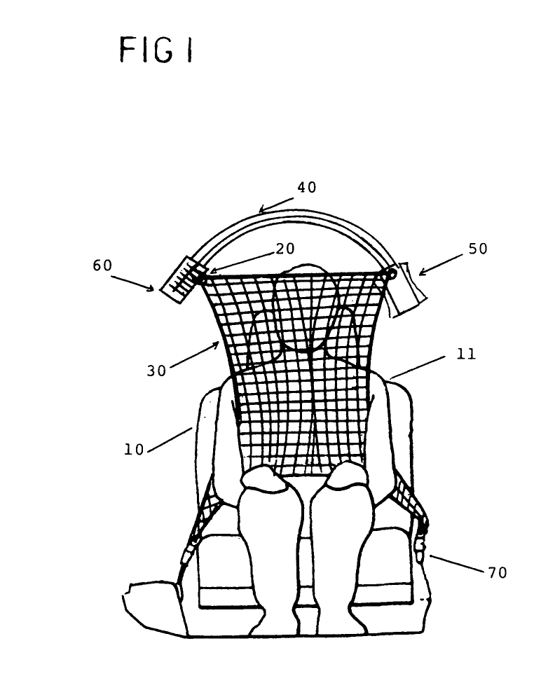

Referring to FIG. 1 is the frontal view of a passenger (11) sitting on a seat (10) with the restraining web (30) fully deployed. Showing also the propelling chamber (50) connected together with the looped channel (40) and the anchor bracket (60).

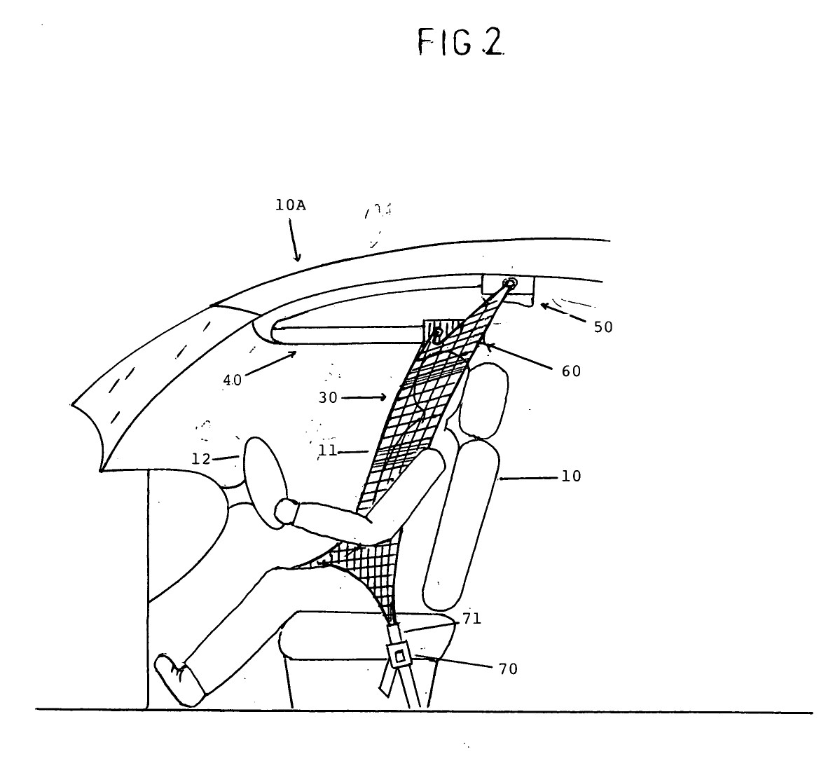

Referring to FIG. 2 is the side view of a driver (11) sitting in a seat (10) holding a steering wheel (12) inside a vehicle (10A) with the restraining web (30) fully deployed and buckled up (70 and 71) at the lower ends, showing also the propelling chamber (50), looped channel (40) and the anchor bracket (60) joined together.

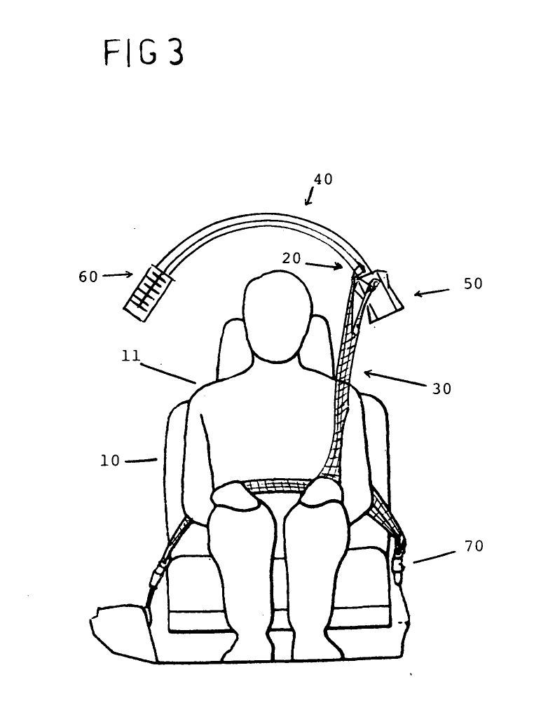

Referring to FIG. 3 is the restraining web (30) in ready position hanging loose at one side of a person (11) sitting in a seat (10) with the lower ends buckled up (70) and the upper ends hooked up with the propelling chamber (50) and the cable guide (20) which is on the track of the looped channel (40) that leads to the anchor bracket (60).

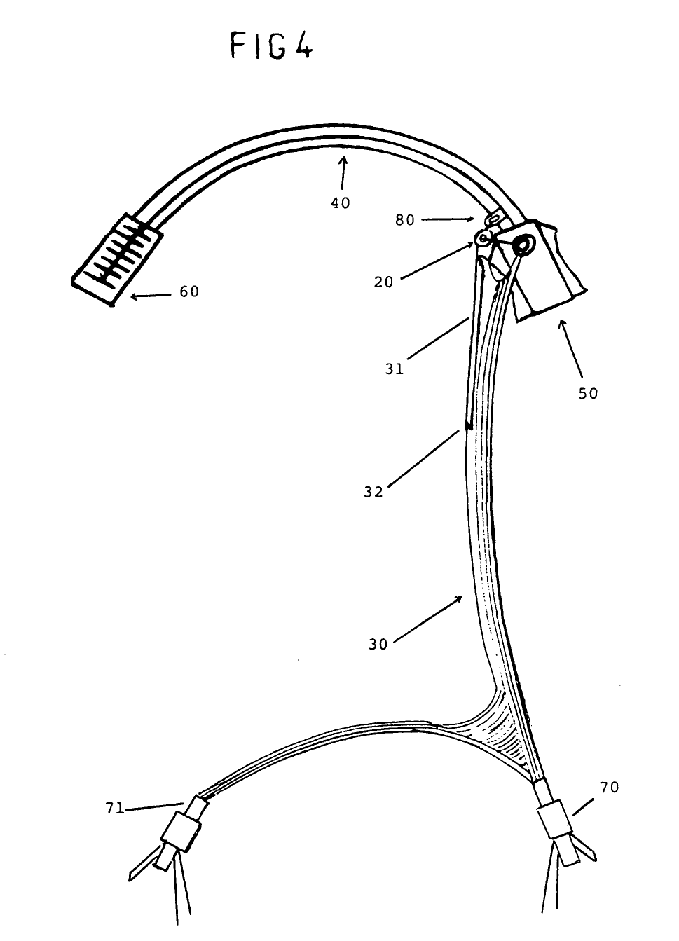

Referring to FIG. 4 is showing an enlarge view of the vehicle driver and passenger restraining device with the web (30) folded in pleats and the upper ends joint (32) is a cable (31) routes through the cable guide (20) back to the stationary end at the propelling chamber (50) it is for adjustment of the web (30) which lower ends buckled up (70 and 71) and adjustment at that ends also, carrying cam (80) with the cable guide (20) attached to will be propelled through the looped channel (40) to anchor at the anchor bracket (60).

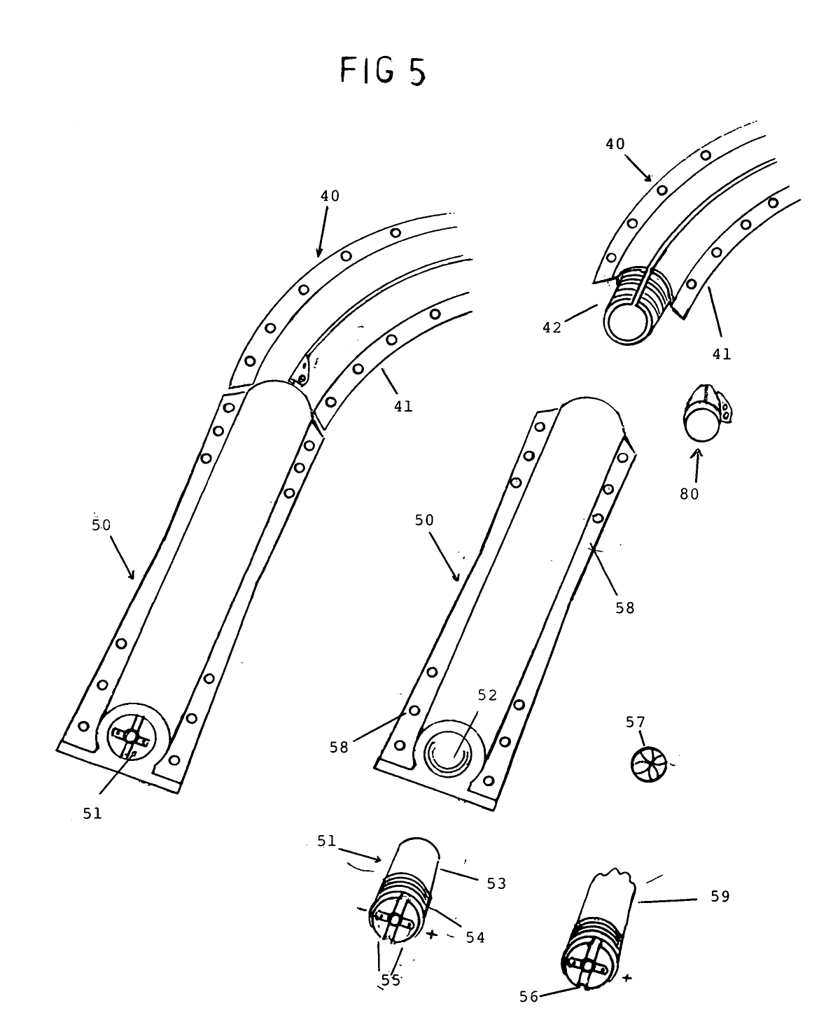

Referring to FIG. 5 is the propelling chamber (50) joining the looped channel (40) with its base and ridge support (41), when dismantled are showing the threaded portion (42) where the propelling chamber (50) with the thick base (58) fitted onto, threaded inner (52) is where the cartridge (51) with threaded base (54) and plastic body (53) and positive and negative terminals (55) fitted into, the cartridge (59) discharges a bouncing ball (57) covered with fireproof yarns. Slot (56) is to facilitate a tool to screw in the cartridge. Carrying cam (80) sits into the looped channel (40) nearest to the propelling chamber (50).

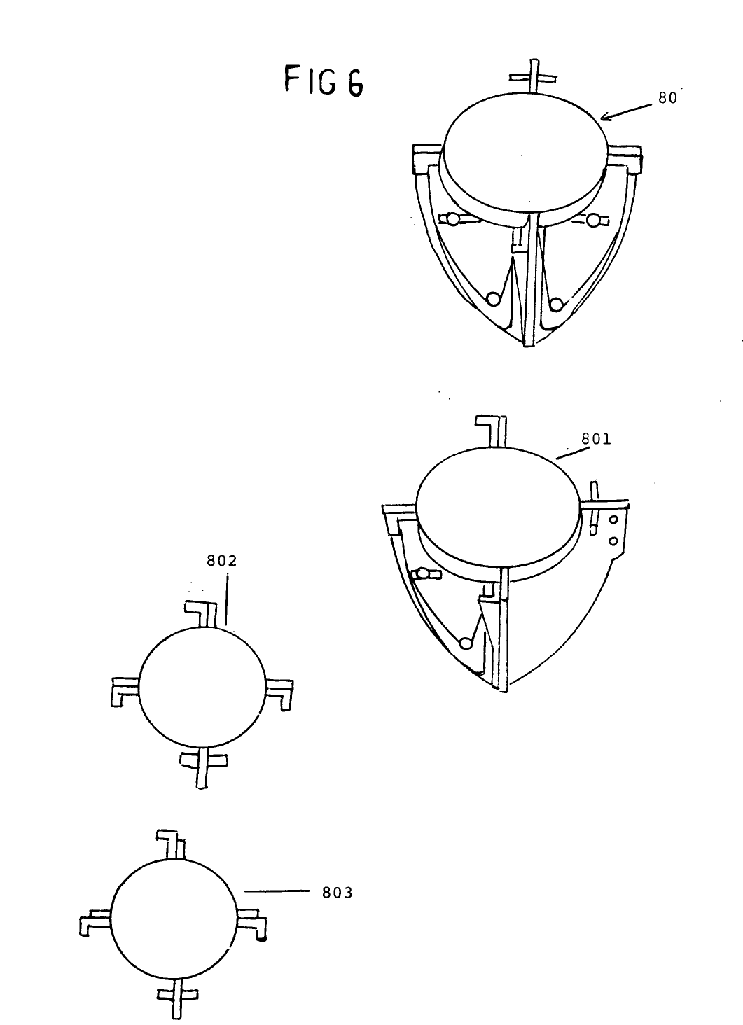

Referring to FIG. 6 (refer to Ser. No. 11/100,236) is the carrying cam (80) viewing from different position, carrying cam (802) when sitting in the looped channel (40), carrying cam (803) after being propelled to anchor bracket (60) with its sliding cams (84) extended to anchor the web (30).

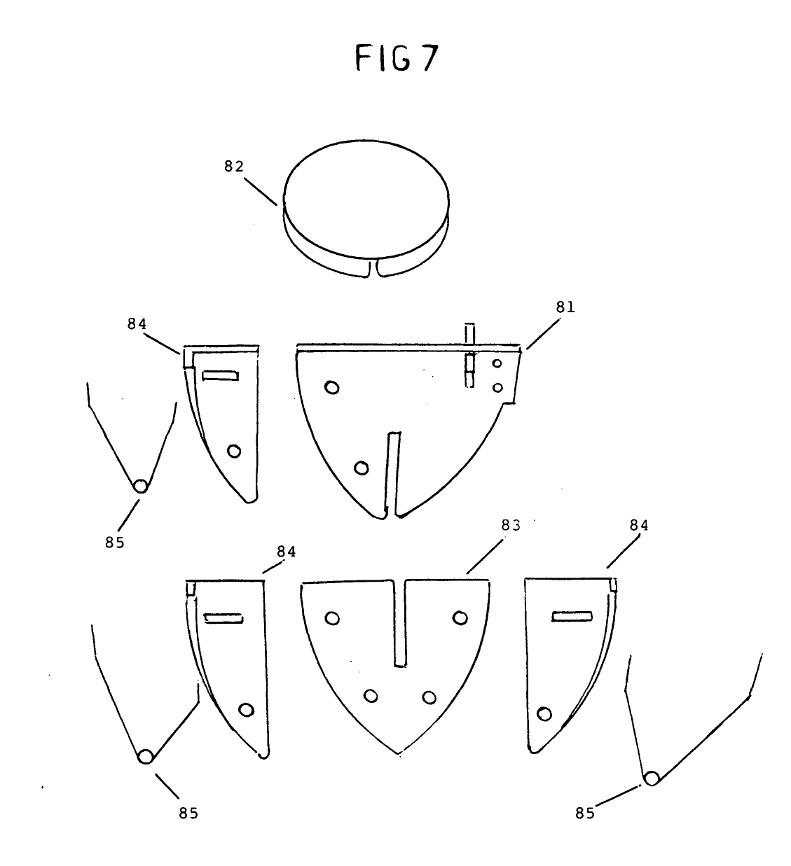

Referring to FIG. 7 (refer to Ser. No. 11/100,236) is showing the different parts of the carrying cam (80), round top (82) accepts the punch of the bouncing ball (57) welded with the stationary plates (81) and (83) attached onto them are the sliding cams (84) which are spring (85) loaded.

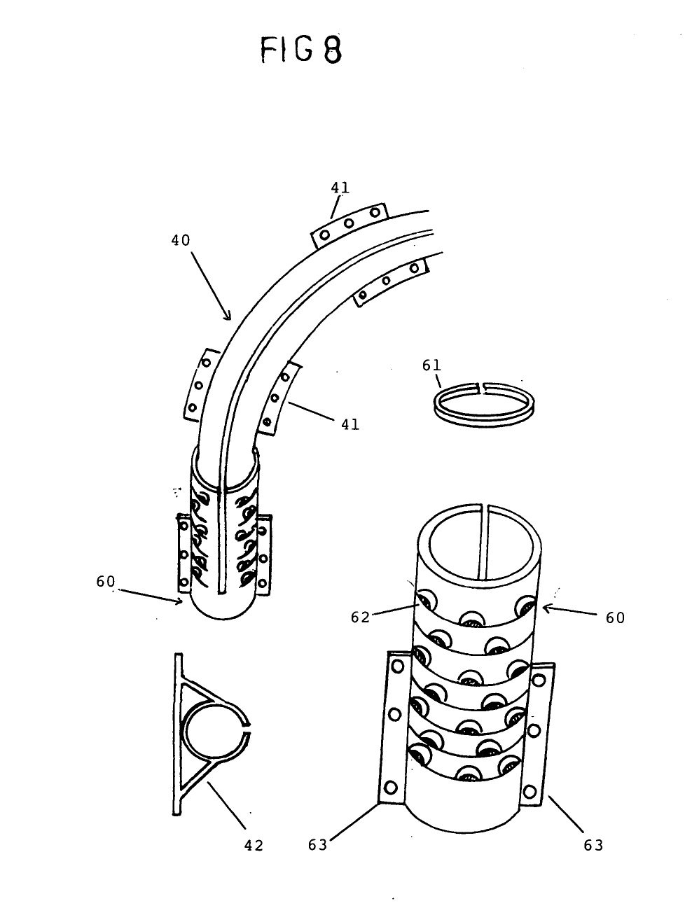

Referring to FIG. 8 is showing the anchor bracket (60) attached at the end of the curved channel (40) with base and ridge reinforcement (41) (42) and ( 63), half-moon dent-ins (62) are functioning as catches for the carrying cam (80). Spacer (61) is placed between the looped channel (40) and the anchor bracket (60).

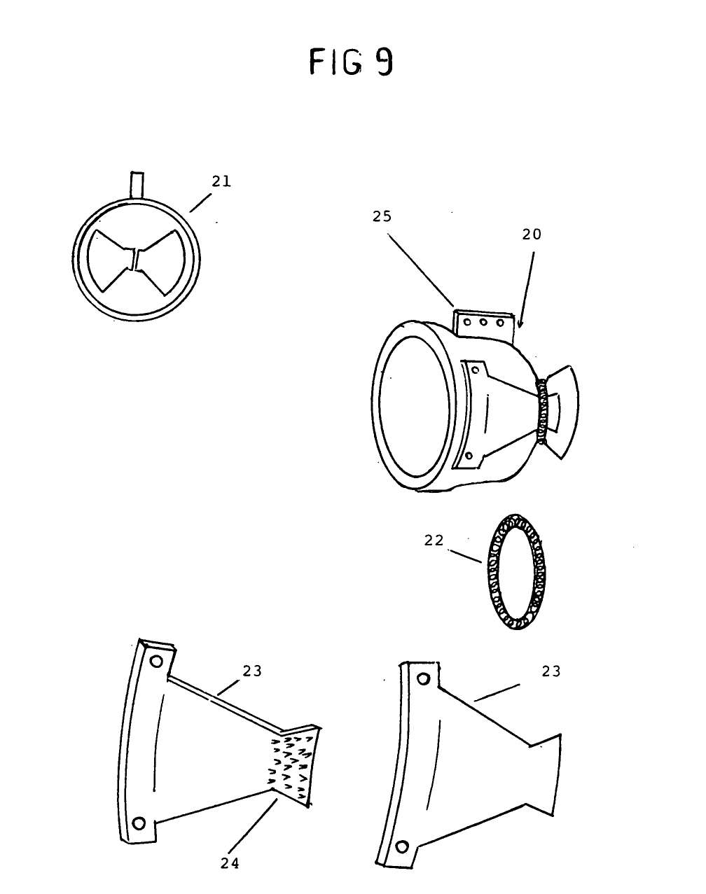

Referring to FIG. 9 is showing the cable guide (20) with the attach bracket (25), the two loose flaps (23) are retained and tensioned with spring (22) have rasp portions (24) pointing backward to ensure non return of the cable (31), looking into the feeding mouth of the cable guide is (21).

### CONCLUSION

It can now be seen that the present invention solves many of the problems associated with the prior arts. The present invention confines the driver and passenger within the web area therefore prevent the violent movement of the body during an accident and protect the vital organs such as the head, the neck and the spine of the driver and passenger which are most vulnerable.

The restraining web is transparent so persons restrained fully comprehend the situation and also have the arms free to continue maneuvering and or unbuckle to walk away. The restraining web is strong and light weight and folded in pleats and can be put on loosely so as not to irritate the sensitive human body. The present invention will not disintegrate and is reusable and it is simple, easy to make and low cost and uses materials already in the marketplace. The present invention can be adapted to all forms of vehicles.

Although the description above contains many specifications, these should not be construed as limiting the scope of the invention but as merely providing support to the illustrations of the preferred embodiment of this invention. For example the propelling system can be that of a multiple variable outlets shooting apparatus ( refer to Ser. No. 11/098,196) especially dealing with more than one set of restraining devices, and the propellant can be of straight shooting gun powder or CO2 cartridge etc.

Thus the scope of this invention should not be determined by the appended claims and their legal equivalents, rather than by the examples given herein.

What is claimed is:

1. A vehicle driver and passenger restraining device provides protection for the driver and passenger during a collision accident comprising of a web having the bottom ends strapped across a person's laps and buckled at both side, the upper ends when in ready position hang loose at one side of the seat said device having a propelling chamber which shoots a carrying cam together with said cable guide and said web along said channel to said anchoring bracket effectively looped and restrained said person.

2. The system of claim 1 wherein said web is folded in pleats with the first and the last one lightly attached with, but not limit to, tac stic or Velcro etc.

3. The system of claim 1 wherein said web can be made of any strong, fire-resistant and light weight sheet material that can be folded into small pleats, such as, but not limit to , rayon and nylon netting etc.

4. The system of claim 1 wherein said web has strong reinforced portions and rims to prevent tearing.

5. The system of claim 1 wherein said web is made as such so when engaged the person restrained still see the surrounding situation and arms free to continue maneuvering.

6. The system of claim 1 wherein said propelling chamber is made of high value steel with strong base and ridge reinforcing said chamber also threaded both ends to fit a power cartridge and fit in said channel.

7. The system of claim 6 wherein said propelling chamber houses said power cartridge which is electronically controlled to propel a bouncing ball and said ball is wrapped with fire-resistant yams to prevent melt and burn.

8. The system of claim 1 wherein said web is hooked on to said carrying cam (refer to Ser. No. 11/098,196) and said cam is made of three spring loaded expanding leaves and one stationary leaf where said web is being hooked on to.

9. The system of claim 1 wherein said channel (refer to Ser. No. 11/089,196) is reinforced with strong base and ridge.

10. The system of claim 1 wherein said anchoring bracket comprising numerous uniform dented-in half moon ridges to ensure non return of the carrying cam.

11. The system of claim 1 wherein said cable guide is to adjust said web and ensure non return of the said cable together with one end of said web.

12. The system of claim 11 wherein said cable guide is made of cylindrical cone with spring loaded loose flaps that allows cable to go in but not back out.
